(19) United States
(12) Patent Application Publication
(10) Pub. No.: US 2016/0182274 A1
(43) Pub. Date: Jun. 23, 2016

(54) SYSTEM AND METHOD OF PRIORITIZING ALARMS WITHIN A NETWORK OR DATA CENTER

(71) Applicants: David B. Kiesekamp, Merrickville (CA); Tania Pilon, Carp (CA); Guangnian Wu, Ottawa (CA); Yves Thibeault, Gatineau (CA)

(72) Inventors: David B. Kiesekamp, Merrickville (CA); Tania Pilon, Carp (CA); Guangnian Wu, Ottawa (CA); Yves Thibeault, Gatineau (CA)

(73) Assignee: ALCATEL-LUCENT CANADA INC., Ottawa (CA)

(21) Appl. No.: 14/573,646

(22) Filed: Dec. 17, 2014

(51) Int. Cl. H04L 12/24; H04L 12/26

(52) U.S. Cl. CPC H04L 41/069; H04L 43/045

(57) ABSTRACT

Systems, methods, architectures, mechanisms and/or apparatus to manage the plurality of network elements within a network by ranking some or all of the alarm types according to respective measurements and performing a visualization function configured to provide image representative data including alarm type representative objects arranged in accordance with said network element ranking.

### FIELD OF THE INVENTION

The invention relates to the field of network and data center management and, more particularly but not exclusively, to management of event data in networks, data centers and the like.

### BACKGROUND

Existing network management systems used within the context of, illustratively, network operations centers (NOCs) provide to operators a visualization of virtual or nonvirtual elements within a deployed communication network or data center. This visualization can be graphically manipulated by the user to provide various management functions. However, while useful, existing network management systems typically require significant human knowledge of the communication network or data center topology as well as the likely sources of failure or operational degradation.

Currently, the network operator relies on filtered and sorted alarm lists to identify alarms that re-occur in the network. If there is an alarm that is causing the entire system to be filled with very high numbers of alarms, then the list and filtering will not be very easy to read or use because of constant operator list scrolling as well as alarm system congestion and slow performance.

The enormous amount of alarms, warnings and other information generated by the (typically) thousands of elements within a communication network or data center is difficult for even the most skilled operator to manage in a timely manner. Further, NEs can create and recreate alarm related events in numbers high enough to clog the alarm management system with too much information (alarm storms) to strain event related resources in addition to straining the ability of operators or users to interpret the information necessary to identify problem NEs.

### SUMMARY

Various deficiencies in the prior art are addressed by systems, methods, architectures, mechanisms and/or apparatus to enable a network operator or user to rapidly identify which events or alarms are the largest contributors to the totality of event or alarm related traffic (e.g., largest alarm sources for an alarm storm) such that the Network Elements (NEs) associated with these events/alarms may be quickly identified and subjected to troubleshooting procedures. This is especially useful within the context of eliminating the re-occurring alarms from NEs such that the network including the NEs may be more easily managed.

Various embodiments contemplate managing alarm traffic within a network by ranking some or all of the various alarm traffic or streams according to alarm/event count, alarms/event per second or other alarm related measure useful in gauging the relative number and/or impact of specific events, alarms, alarm streams/traffic within the network. An alarm visualization function is configured to provide image representative data of the highest ranked event/alarm streams such that network elements associated with these event/alarm streams may be quickly identified and subjected to troubleshooting procedures to determine if the event/alarm streams may be reduced or simply ignored.

Various elements provide a visual representation of high ranked event/alarm streams such as a user manipulable histogram (or other representation) of alarm streams arranged according to rank wherein user selection of an alarm stream representative element in the histogram results in the display of the network elements associated with the selected alarm stream. In this manner, an operator or user is provided with an efficient path or sequence of NEs for troubleshooting and/or other workflow purposes.

### BRIEF DESCRIPTION OF THE DRAWINGS

The teachings herein can be readily understood by considering the following detailed description in conjunction with the accompanying drawings, in which:

FIG. 1 depicts a high-level block diagram of a system useful in illustrating various embodiments.

FIG. 2 depicts an exemplary management system suitable for use in the system of FIG. 1;

FIGS. 3A and 3B depict a flow diagram of methods according to various embodiments;

FIGS. 4-7 depict user interface display screens for presenting network element information to operators or users in accordance with various embodiments; and

FIG. 8 depicts a high-level block diagram of a computing device suitable for use in performing the functions described herein.

To facilitate understanding, identical reference numerals have been used, where possible, to designate identical elements that are common to the figures.

### DETAILED DESCRIPTION OF THE INVENTION

The invention will be discussed within the context of systems, methods, architectures, mechanisms and/or apparatus to visualize for an operator or user managing a network the most numerous or impactful event/alarm streams in the network, along with corresponding network elements (NEs), so that the operator or user may rapidly prioritize the events/alarms (or NEs) that should be investigated or subjected to troubleshooting procedures first.

Various embodiments described herein relate to a visualization tool for generating visualization graphical user interface (GUI) imagery and/or other imagery presented to operators are users managing a network or data center. In particular, within the context of managing a network or data center the operators or users perform various troubleshooting, maintenance and other tasks in response to information pertaining to the various virtual and nonvirtual entities, network elements, communications links and so on forming a network or data center being managed.

An exemplary visualization tool may include a computer program that generates management display visualizations adapted to prioritize operator/user efforts, provide operational and performance information pertaining to virtual and nonvirtual network elements, communications links and other managed entities. The computer program may be executed within the context of a management system (MS) implemented in whole or in part at a network operations center (NOC) or other location.

Various embodiments contemplate managing alarm traffic within a network by ranking some or all of the various alarm traffic or streams according to alarm/event count, alarms/event per second or other alarm related measure useful in gauging the relative number and/or impact of specific events, alarms, alarm streams/traffic within the network. An alarm visualization function is configured to provide image representative data of the highest ranked event/alarm streams such that network elements associated with these event/alarm streams may be quickly identified and subjected to troubleshooting procedures to determine if the event/alarm streams may be reduced or simply ignored.

Various elements provide a visual representation of high ranked event/alarm streams such as a user manipulable histogram (or other representation) of alarm streams arranged according to rank wherein user selection of an alarm stream representative element in the histogram results in the display of the network elements associated with the selected alarm stream. In this manner, an operator or user is provided with an efficient path or sequence of NEs for troubleshooting and/or other workflow purposes.

It will be appreciated by those skilled in the art that the invention has broader applicability than described herein with respect to the various embodiments.

Various embodiments present the operator or user with an ordered visualization of the top N (e.g., 50) alarms in terms of alarm count, impact or other criteria; that is, the top N most numerous or impactful even/alarm streams. In this manner, the operator or user is provided with an easily understandable visual tool for efficiently guiding the troubleshooting or workflow efforts of the operator or user. In particular, the NEs associated with the top N alarms are clearly identified such that the operator or user may investigate these NEs (or their events/alarms) in sequence in descending order of count or impact such that the largest troubleshooting result for the least amount of troubleshooting time may be achieved. Further, the various visualizations provide a quick reference enabling operators and users to quickly verify particular problems within a group of NEs, such as in a communications network or data center.

Generally speaking, various embodiments provide an operator or user with a starting point for troubleshooting problems in a network or data center by visualizing alarm information in a useful manner.

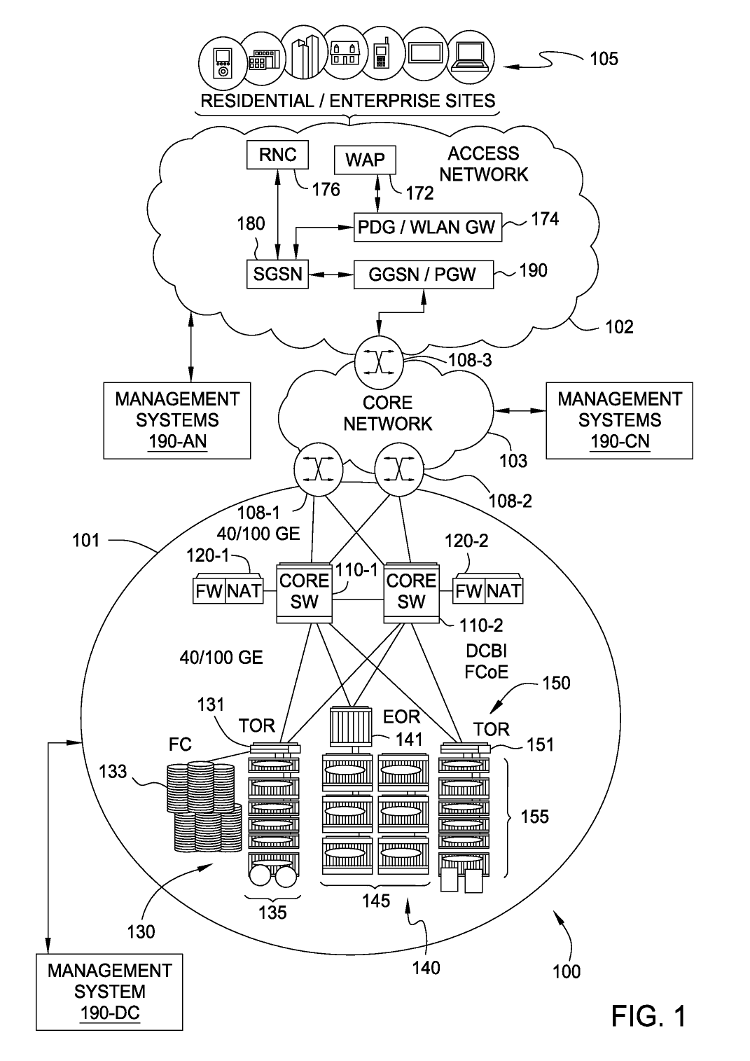

FIG. 1 depicts a high-level block diagram of a system useful in illustrating various embodiments. Specifically, FIG. 1 depicts a system 100 comprising multiple groups of managed network elements NEs, illustratively an access network 102, a core network 103 and a data center 101. More or fewer groups of managed network elements may be used within the context of various embodiments. In particular, the system 100 of FIG. 1 is really intended to illustrate that any group of managed network elements may benefit from the teachings of the various embodiments.

Referring to FIG. 1, the access network 102 supports communications between residential and/or enterprise sites 105 and the core network 103. The core network 103 supports communications between the access network 102 and the data center 101. The data center 101 communicates with the core network 103 via, illustratively, first and second provider edge (PE) routers 108-1 and 108-2. Similarly, the access network 102 communicates with the core network 103 via, illustratively, third PE router 108-3.

User equipment (UE) of the residential/enterprise sites 105 may comprise a smart phone, tablet computer, laptop computer, set top box (STB) or any other wireless wireline device capable of receiving packets or traffic flows such as associated with Service Data Flows (SDFs), Application Flows (AFs), mobile services, voice communications, electronic mail, messages and/or types of data.

Different types of UE may be utilized depending upon the characteristics of the access network 102 (e.g., wireless access network, wireline access network etc.). For example, the different types of UE, such as UE capable of accessing a mobile network directly via a Radio Network Controller (RNC) and/or via a wireless access point (WAP). The mobile network may comprise a 3G/4G mobile network such as a 3GPP network, Universal Mobile Telecommunications System (UMTS) network, long-term evolution (LTE) network and so on. The WAP may be associated with a Wi-Fi, WiMAX or other wireless access network. It will be noted that large numbers of UE may also be used.

The access network 102 and core network 103 may comprise any of a plurality of available access network and/or core network topologies and protocols, alone or in any combination, such as Virtual Private Networks (VPNs), Long Term Evolution (LTE), Border Network Gateway (BNG), Internet networks and the like. For illustrative purposes, the access network 102 of FIG. 1 is depicted as a wireless access network including multiple instances of various known network elements such as Wireless Access Point (WAP) 172, Packet Data Gateway (PDG)/Wireless LAN gateway (WLAN-GW) 174, Radio Network Controller (RNC) 176, Serving GPRS Support Node (SGSN) 180, Gateway GPRS Support Node (GGSN)/Packet Gateway (PGW) 190 as well as various other network elements (not shown) supporting control plane and/or data plane operations.

The data center 101 is depicted as comprising a plurality of core switches 110, a plurality of service appliances 120, a first resource cluster 130, a second resource cluster 140, and a third resource cluster 150. The DC 101 is generally organized in cells, where each cell can support thousands of servers and virtual machines.

Each of, illustratively, two PE nodes 108-1 and 108-2 is connected to each of the, illustratively, two core switches 110-1 and 110-2. More or fewer PE nodes 108 and/or core switches 110 may be used; redundant or backup capability is typically desired. The PE routers 108 interconnect the DC 101 with the networks 102 and, thereby, other DCs 101 and end-users 105. The DC 101 is generally organized in cells, where each cell can support thousands of servers and virtual machines.

Each of the core switches 110-1 and 110-2 is associated with a respective (optional) service appliance 120-1 and 120-2. The service appliances 120 are used to provide higher layer networking functions such as providing firewalls, performing load balancing tasks and so on.

The resource clusters 130-150 are depicted as compute and/or storage resources organized as racks of servers implemented either by multi-server blade chassis or individual servers. Each rack holds a number of servers (depending on the architecture), and each server can support a number of processors. A set of network connections connect the servers with either a Top-of-Rack (ToR) or End-of-Rack (EoR) switch. While only three resource clusters 130-150 are shown herein, hundreds or thousands of resource clusters may be used. Moreover, the configuration of the depicted resource clusters is for illustrative purposes only; many more and varied resource cluster configurations are known to those skilled in the art. In addition, specific (i.e., non-clustered) resources may also be used to provide compute and/or storage resources within the context of DC 101.

Exemplary resource cluster 130 is depicted as including a ToR switch 131 in communication with a mass storage device(s) or storage area network (SAN) 133, as well as a plurality of server blades 135 adapted to support, illustratively, virtual machines (VMs). Exemplary resource cluster 140 is depicted as including an EoR switch 141 in communication with a plurality of discrete servers 145. Exemplary resource cluster 150 is depicted as including a ToR switch 151 in communication with a plurality of virtual switches 155 adapted to support, illustratively, the VM-based appliances.

In various embodiments, the ToR/EoR switches are connected directly to the PE routers 108. In various embodiments, the core or aggregation switches 120 are used to connect the ToR/EoR switches to the PE routers 108. In various embodiments, the core or aggregation switches 120 are used to interconnect the ToR/EoR switches. In various embodiments, direct connections may be made between some or all of the ToR/EoR switches.

A VirtualSwitch Control Module (VCM) running in the ToR switch gathers connectivity, routing, reachability and other control plane information from other routers and network elements inside and outside the DC. The VCM may run also on a VM located in a regular server. The VCM then programs each of the virtual switches with the specific routing information relevant to the virtual machines (VMs) associated with that virtual switch. This programming may be performed by updating L2 and/or L3 forwarding tables or other data structures within the virtual switches. In this manner, traffic received at a virtual switch is propagated from a virtual switch toward an appropriate next hop over a tunnel between the source hypervisor and destination hypervisor using an IP tunnel. The ToR switch performs just tunnel forwarding without being aware of the service addressing.

Generally speaking, the “end-users/customer edge equivalents” for the internal DC network comprise either VM or server blade hosts, service appliances and/or storage areas. Similarly, the data center gateway devices (e.g., PE servers 108) offer connectivity to the outside world; namely, Internet, VPNs (IP VPNs/VPLS/VPWS), other DC locations, Enterprise private network or (residential) subscriber deployments (BNG, Wireless (LTE etc), Cable) and so on.

The access network 102 is associated with a management system (MS) 190-AN, the core network 103 is associated with a management system 190-CN and the data center 101 is associated with a management system 190-DC. Each of the management systems 190 is adapted to support various management functions associated with its respective network or data center; more particularly, to communicate with the respective group of network elements (NEs) within that network or data center. Each MS 190 may also be adapted to communicate with other operations support systems (e.g., Element Management Systems (EMSs), Topology Management Systems (TMSs), and the like, as well as various combinations thereof).

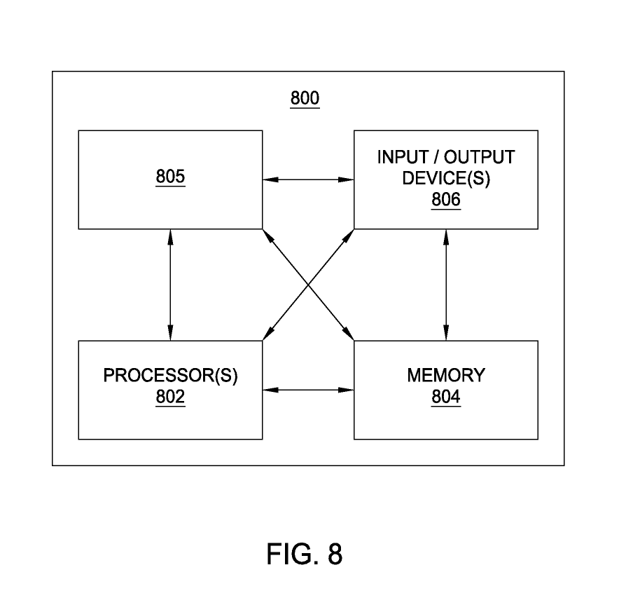

Each MS 190 may be implemented at a network node, network operations center (NOC) or any other location capable of communication with the relevant portion of the system 100, such the data center 101, access network 102 or core network 103. Each MS 190 may be implemented as a general purpose computing device or specific purpose computing device, such as described below with respect to FIG. 8.

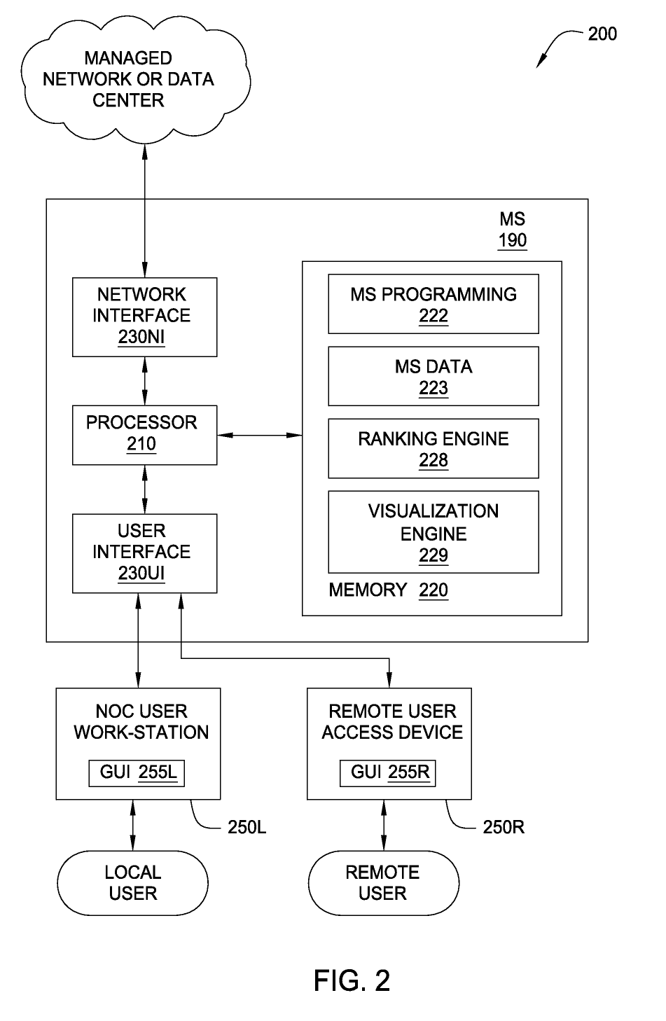

FIG. 2 depicts an exemplary management system suitable for use as the management system of FIG. 1. As depicted in FIG. 2, MS 190 includes one or more processor(s) 210, a memory 220, a network interface 230NI, and a user interface 230UI. The processor(s) 210 is coupled to each of the memory 220, the network interface 230NI, and the user interface 230UI.

The processor(s) 210 is adapted to cooperate with the memory 220, the network interface 230NI, the user interface 230UI and various support circuits (not shown) to provide various management functions for a group of network elements being managed, such as a group of network elements within the data center 101, access network 102 or core network 103 discussed above with respect to the system 100 of FIG. 1.

The memory 220, generally speaking, stores programs, data, tools and the like that are adapted for use in providing various management functions for a group of network elements being managed, such as a group of network elements within the data center 101, access network 102 or core network 103 discussed above with respect to the system 100 of FIG. 1.

The memory 220 includes various management system (MS) programming modules 222 and MS databases 223 adapted to implement network management functionality such as discovering and maintaining network topology, processing VM related requests (e.g., instantiating, destroying, migrating and so on) and the like as appropriate to the group of network elements being managed.

The memory 220 includes a ranking engine 228 operative to rank the various alarms (i.e., the event or alarm streams) in accordance with alarm count, alarm occurrence rate, alarm source NEs, alarm impact on NEs and/or other criteria to determine those alarms (and corresponding NEs) that should be prioritized for troubleshooting purposes. The various alarms may be identified by type, source, importance or other criteria. In particular, various embodiments are directed to focusing operator or user attention upon the top N most numerous or impactful alarms and their respective sources (network elements). Ranking engine 228 is configured to process event/alarm information and/or impact information associated with a group of managed network elements to determine thereby a ranking or ordering of the N most numerous or impactful alarms.

The memory 220 also includes a visualization engine 229 operable to process alarm ranking information as well as other information to define imagery suitable for use within the context of graphical user interface (GUI) accessed by a network or data center operator or user, such as within the context of an alarm visualization function in which graphic elements or objects corresponding to alarms of differing types are generated for use within the context of a graphical user interface or other imagery presented to an operator or user, or within the context of a network element visualization function in which graphic elements or objects corresponding to network elements are generated for use within the context of a graphical user interface or other imagery presented to an operator or user.

For example, various objects intended for display may be defined for at least the top N most numerous or impactful alarms, wherein the objects include alarm type information, alarm count or rate of alarm occurrence information, number and/or identity of NEs generating the same alarm, number and/or identity of NEs impacted by the alarms and various other information. Further, the graphic/image properties associated with the objects may be adapted in response to the alarm count or rate of alarm occurrence information, number and/or identity of NEs generating the same alarm, number and/or identity of NEs impacted by the alarms and various other information.

In various embodiments, the MS programming module 222, ranking engine 228 and visualization engine 229 are implemented using software instructions which may be executed by a processor (e.g., processor(s) 210) for performing the various management functions depicted and described herein.

The network interface 230NI is adapted to facilitate communications with various network elements, nodes and other entities within the system 100, data center 101, access network 102, core network 103 or other network element group to support the management functions performed by MS 190.

The user interface 230UI is adapted to facilitate communications with one or more local user workstations 250L (e.g., local to a Network Operations Center (NOC)) or remote user access devices 250R (e.g., remote user computer or other access device) in communication with the MS 190 and enabling operators or users to perform various management functions associated with a group of network elements being managed via, illustratively, a graphical user interface (GUI) 255.

As described herein, memory 220 includes the MS programming module 222, MS databases 223, ranking engine 228 and visualization engine 229 which cooperate to provide the various functions depicted and described herein. Although primarily depicted and described herein with respect to specific functions being performed by and/or using specific ones of the engines and/or databases of memory 220, it will be appreciated that any of the management functions depicted and described herein may be performed by and/or using any one or more of the engines and/or databases of memory 220.

The MS programming 222 adapts the operation of the MS 190 to manage various network elements, DC elements and the like such as described herein with respect to the various figures, as well as various other network elements (not shown) and/or various communication links therebetween. The MS databases 223 are used to store topology data, network element data, service related data, VM related data, communication protocol related data and/or any other data related to the operation of the Management System 190. The MS program 222 may be implemented within the context of a Service Aware Manager (SAM) or other network manager.

Workstation 250L and remote user access device 250R may comprise computing devices including one or more processors, memory, input/output devices and the like suitable for enabling communication with the MS 190 via user interface 230UI, and for enabling one or more operators or users to perform various management functions associated with a group of network elements being managed via, illustratively, a graphical user interface (GUI) 255.

The GUI 255L of workstation 250L, as well as the GUI 255R of user access device 250R, may be implemented via processor and a memory communicatively connected to the processor, wherein the memory stores software instructions which configure the processor to perform various GUI functions in accordance with the embodiments described herein, such as to present GUI imagery to an operator or user, receive GUI object selection indicative data as well as other input information from an operator or user, and generally support and interaction model wherein the GUI provides a mechanism for user interaction with various elements of the MS 190.

Generally speaking, workstation 250L and remote user access device 250R may be implemented in a manner similar to that described herein with respect to MS 190 (i.e., with processor(s) 210, memory 220, interfaces 230 and so on) and/or as described below with respect to the computing device 800 of FIG. 8. In various embodiments the workstation 250L comprises a dedicated workstation or terminal within a NOC. In various embodiments, the remote user access device 250R comprises a general purpose computing device including a browser, portal or other client-side software environment supporting the various MS 190 communications functions as well as the various GUI functions described herein.

Each virtual and nonvirtual network element generating events communicates these events to the MS 190 or other entity via respective event streams. The MS 190 processes the event streams as described herein and, additionally, maintains an event log associated with each of the individual event stream sources. In various embodiments, combined event logs are maintained. Further, various events may be categorized as critical alarms, major alarms, minor alarms, warnings and so on. Further, various events may be processed to identify specific failed network elements including root cause failed network elements (i.e., failed network elements which are the cause of failure of other network elements). Further, various events may be processed to identify the number of network elements impacted by the failure of a particular network element.

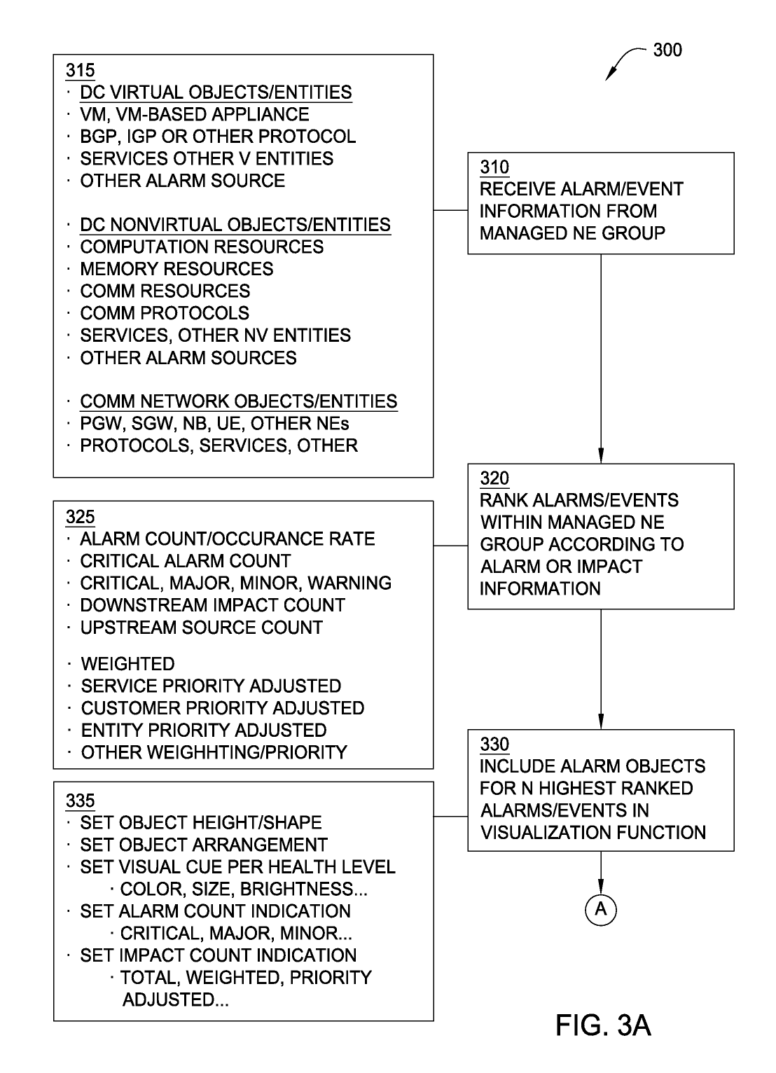

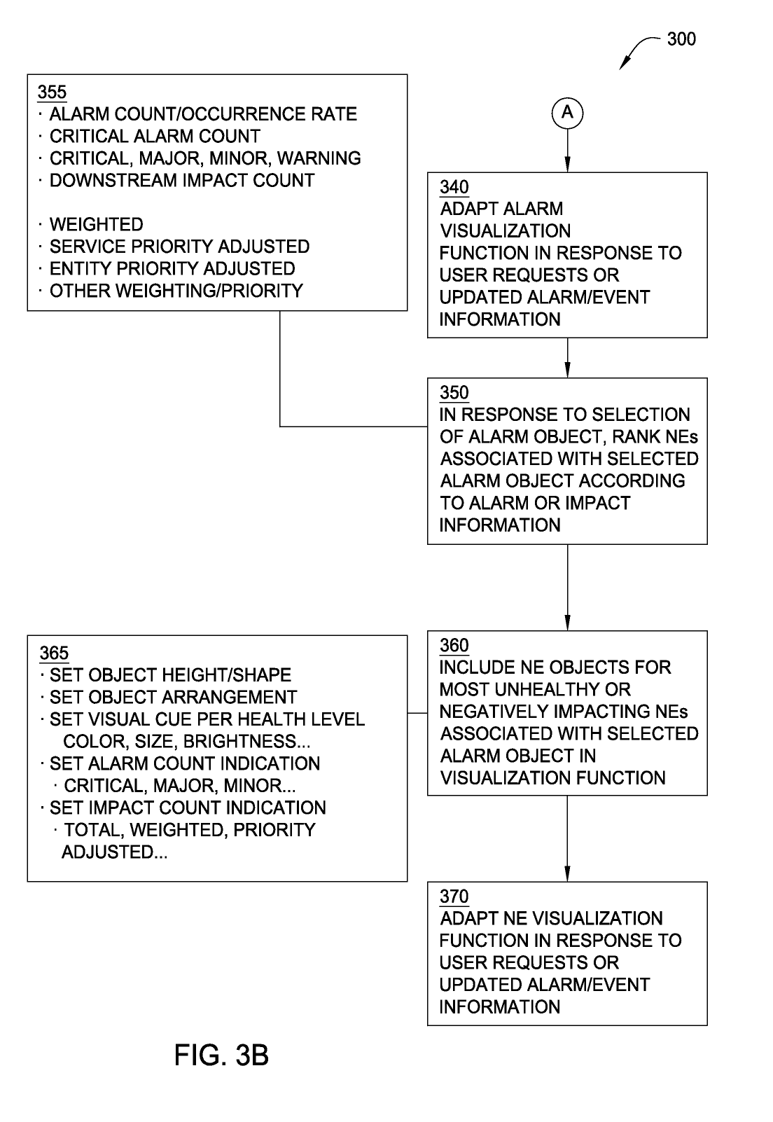

FIG. 3 depicts a flow diagram of a method according to one embodiment. Specifically, the method 300 of FIG. 3 contemplates various steps performed by, illustratively, the ranking engine 228, visualization engine 229 and/or other MS programming mechanisms 222 associated with the management system 190. In various embodiments, the ranking engine 228, visualization engine 229 and/or other MS programming mechanisms 222 are separate entities, partially combined or combined into a single functional module. In various embodiments, these functions are performed within the context of a general management function, an event/alarm processing function, an alarm generation function or other function.

At step 310, alarm/event information is received from NEs within the plurality of NEs being managed, such as from network elements, objects, entities etc. within a communications network, data center and the like. Referring to box 315, DC virtual objects/entities may comprise virtual objects/entities such as virtual machines (VMs) or VM-based appliances, Border Gateway Protocol (BGP), Interior Gateway Protocol (IGP) or other protocols, user or supervisory services, or other virtual objects/entities or network elements within a group of network elements being managed. Similarly, DC nonvirtual objects/entities may comprise computation resources, memory resources, communication resources, communication protocols, user or supervisory services/implementations and other nonvirtual objects/entities or network elements within a group of network elements being managed. Similarly, communication network objects/entities may comprise PGW, SGW, NB, UE and/or other network elements, as well as protocols, services or any other managed entity or network element within a group of network elements being managed.

At step 320, the alarms/events (or alarm/event streams) within the plurality of NEs being managed are ranked according to alarm or impact information. Referring to box 325, information useful in ranking the alarms/events may comprise alarm count, alarm a current rate, critical alarm count, critical, major, minor or warning information and the like. Impact information may comprise downstream impact count (i.e., the number of downstream network elements impacted by the event/alarm condition) and upstream impact count (i.e., the number of network elements generating an event/alarm of a common type. Further, the alarm or impact information may be adapted according to various weighting or other criteria. Further, the alarm or impact information may be service priority adjusted (i.e., weighted more heavily for some services), customer priority adjusted (i.e., weighted more heavily for some customers), entity priority adjusted (i.e., weighted more heavily for some network elements or other entities), and/or some other weighting or priority adjustment mechanism. Generally speaking, step 320 provides a ranking of alarms/events in descending order according to the various ranking criteria. The specific alarm ranking criteria may comprise default criteria or may be selected via policy information received from a network operator, via operator or user interaction with the management GUI, or via some other mechanism.

At step 330, objects for the N most highly ranked alarms/events are included within an alarm visualization function. That is, alarm/event representative objects are generated for at least the N most numerous and/or impactful alarms/events, the alarm/event representative objects are configured for subsequent display within the context of a screen or GUI image presented to a network or data center or user. Referring to box 335, various criteria associated with the alarm/event representative objects may be set, including object shape (e.g., square, round, triangular and so on), object arrangement (e.g., multiple objects provided as histogram, grid, pie chart and so on), object visual cues associated with respective alarm/event rank (e.g., object color, object size, object brightness and so on), alarm count indication (number of all alarms, critical alarms, major alarms, minor alarms, warnings and so on), impact count indication (e.g., number of impacted upstream or downstream network elements, weighted or priority adjusted number of impacted network elements and so on). Object display criteria may be selected via policy information received from a network operator, via operator or user interaction with the management GUI, or via some other mechanism.

Further, the number of objects to be displayed may be less than the total number of objects in the group of objects, or the total number of alarm types available. The number of objects to be displayed may comprise a predefined number of objects or a selectable number of objects. For example, the number of objects may be selectable via policy information received from a network operator, via object display criteria received from the operator or user via interaction with the management GUI, or via some other mechanism.

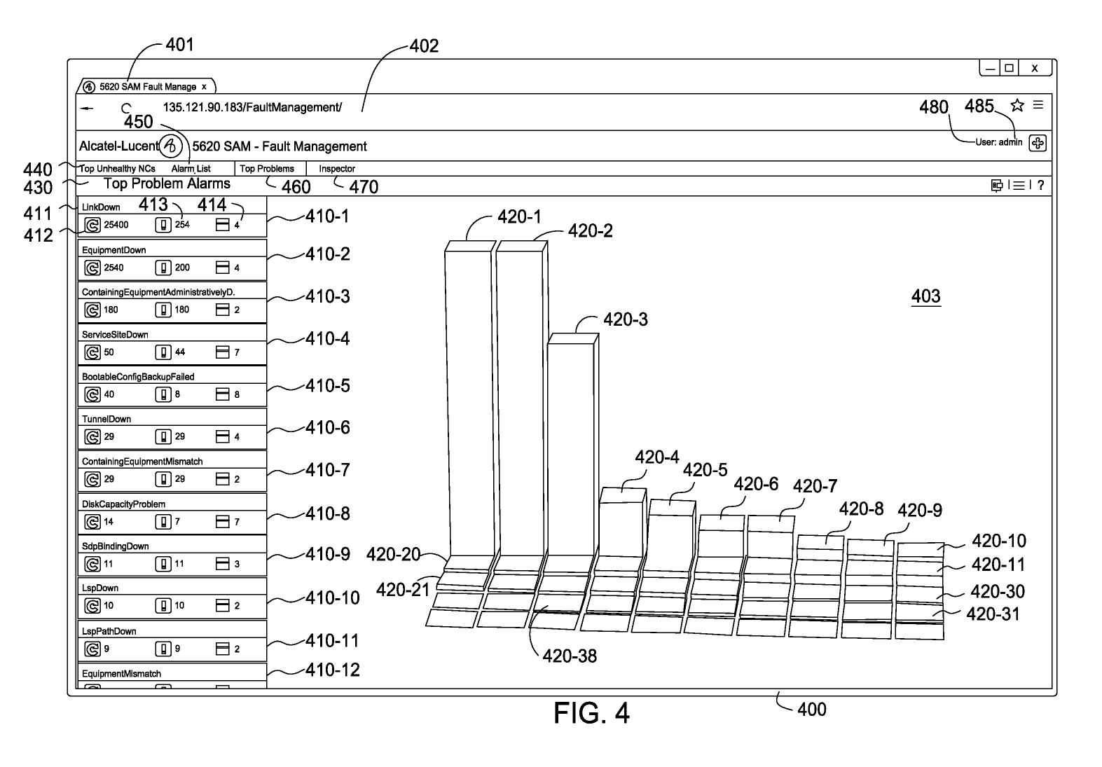

For example, in various embodiments a histogram visualization is used wherein the height and/or color of an alarm/event representative object or element within the histogram is related to the number of occurrences, occurrence rate and/or impact of the represented alarm/event. In various embodiments, the histogram visualization contemplates an arrangement of up to N elements from tallest to shortest. This arrangement may be two-dimensional (e.g., from left to right, or from right to left) or three-dimensional (including a foreground or background dimension providing additional rows/columns such as depicted below with respect to FIGS. 4-7.

In various embodiments, different colors are used in addition to or instead of shape/height parameters. For example, a total height of a histogram element may represent a total number of occurrences of an event/alarm, while a colored portion or portions of the histogram may represent an impact-related parameter associated with the event/alarm, an occurrence rate associated with the event/alarm or some other information.

The objects to be displayed represent the most high priority alarm/event streams. In various embodiments, priority of operator or user attention may be indicated by color, where red requires immediate attention, yellow requires eventual attention and green requires little or no attention. That is, visual cues are used to clearly indicate to an operator or user that particular objects are associated with the alarms/events (or network elements generating such alarms/events) most in need of troubleshooting or attention.

At step 340, the alarm visualization function is adapted in response to user requests or updated alarm/event information. For example, the alarm visualization function may be adapted in response to differing weighting criteria and the like. Similarly, the alarm visualization function may be adapted in response to changes in alarm information such as by deleting those alarms/events deemed to be irrelevant or consistent with current network operation (e.g., generated by partially provisioned network elements were such alarm generation is expected), but troubleshooting alarm/event sources (e.g., at a network element) and so on.

At step 350, in response to data indicative of an operator or user selection of an alarm object such as a histogram element, the NEs within the plurality of NEs being managed that are also associated with the selected alarm/event object (e.g., those NEs generating alarms of the same type) are ranked according to alarm or impact information. Referring to box 355, alarm information useful in ranking the NEs may comprise alarm count, critical alarm count, critical, major, minor or warning information and the like. Impact information may comprise downstream impact count and the like. Further, the alarm or impact information may be adapted according to various weighting or other criteria. Further, the alarm or impact information may be service priority adjusted (i.e., weighted more heavily for some services), customer priority adjusted (i.e., weighted more heavily for some customers), entity priority adjusted (i.e., weighted more heavily for some network elements or other entities), and/or some other weighting or priority adjustment mechanism. Generally speaking, step 320 provides a ranking of network elements in descending order according to network element ranking criteria. The specific network element ranking criteria may comprise default criteria or may be selected via policy information received from a network operator, via operator or user interaction with the management GUI, or via some other mechanism.

At step 360, objects for the N most unhealthy or negatively impacting network elements associated with the selected alarm/event object are included within a network element visualization function. That is, network element representative objects are generated for at least the N most unhealthy or negatively impacting network elements associated with the selected alarm/event object, the network element representative objects configured for subsequent display within the context of a screen or GUI image presented to a network or data center or user. Referring to box 365, various criteria associated with the network element representative objects may be set, including object shape (e.g., square, round, triangular and so on), object arrangement (e.g., multiple objects provided as a grid, pie chart and so on), object visual cues associated with respective network element health level (e.g., object color, object size, object brightness and so on), alarm count indication (number of all alarms, critical alarms, major alarms, minor alarms, warnings and so on), impact count indication (e.g., number of impacted network elements, weighted or priority adjusted number of impacted network elements and so on). Object display criteria may be selected via policy information received from a network operator, via operator or user interaction with the management GUI, or via some other mechanism.

Further, the number of objects to be displayed may be less than the total number of objects in the group of objects, or the total number of NEs in the group of managed NEs. The number of objects to be displayed may comprise a predefined number of objects or a selectable number of objects. For example, the number of objects may be selectable via policy information received from a network operator, via object display criteria received from the operator or user via interaction with the management GUI, or via some other mechanism.

For example, in various embodiments red objects represent the most unhealthy network elements, yellow objects represent relatively healthier network elements, and green objects represent healthy network elements. Similarly, some embodiments contemplate larger objects and/or brighter objects representing less healthy network elements. Generally speaking, visual cues are used to clearly indicate to an operator or user that particular objects are associated with network elements most in need of troubleshooting or attention (i.e., the most unhealthy network elements).

At step 370, the network element visualization function is adapted in response to user requests or updated alarm/event information. For example, the network element visualization function may be adapted in response to differing weighting criteria and the like. Similarly, the network element visualization function may be adapted in response to changes in alarm information such as a reduction in downstream network element alarms due to troubleshooting/repair of upstream network elements.

FIGS. 4-7 depict user interface display screens for presenting alarm/event information to operators or users in accordance with various embodiments. Generally speaking, various embodiments provide an operator or user with a starting point for troubleshooting problems in a network or data center by visualizing alarm/event information in a useful manner via, illustratively, a graphical user interface (GUI) displaying imagery and objects in accordance with the descriptions herein.

FIG. 4 depicts a user interface display 400, illustratively within the context of a browser window or tab 401 associated with an address field 402 and image region 403. The browser window may comprise any client browser program such as Internet Explorer, Chrome, Opera, Safari, Firefox and so on. Other client-side programs suitable for this purpose are well known to those skilled in the art. Generally speaking, imagery, objects and user functionality including various visualization functions may be provided or displayed within the context of the user interface display 400 is provided to an operator or user via a client computing device executing software associated with the browser program and communicating with a local (e.g., NOC) or remote server or host computing device such as indicated within address field 402.

The user interface display 400 comprises a top alarm interface screen and includes an image region 403 including a plurality of alarm/event representative objects; namely, alarm tiles 410-1 through 410-38 (only objects 410-1 through 410-12 are visible) and corresponding alarm histogram elements 420-1 through 420-38.

It is noted that more or fewer objects may be displayed. Various embodiments contemplate the display of up to N objects 410/420, where N is a number such as 25, 50, 100 or some other amount sufficient to show enough objects to provide meaningful information to the operator or user, yet not so large as to overwhelm the operator or user with information.

In the depicted embodiment, information fields within the alarm tile objects 410 comprise, illustratively, alarm identification field 411, alarm reoccurrence field 412, alarm occurrence field 413 and related network element field 414.

The alarm identification field 411 identifies a particular type of alarm, such as Link Down (410-1), Equipment Down (410-2), Containing Equipment Administratively Down (410-3), Service Site Down (410-4), Bootable Config Backup Failed (410-5), Tunnel down (410-6), Containing Equipment Mismatch (410-7), Disk Capacity Problem (410-8), STP Binding Down (410-9), LSP Down (410-10), LSP Path Down (410-11), Equipment Mismatch (410-12) and so on.

The alarm reoccurrence field 412 identifies a number of times the identified alarm has been repeated by the network elements associated with the identified alarm.

The alarm occurrence field 413 identifies a number of times that a unique (i.e., not repeated) alarm has occurred.

The related network element field 414 identifies a number of network elements associated with the generation of alarms associated with the particular alarm tile object.

The various fields described herein may comprise default fields, user configurable fields, network provider configurable fields and so on. In addition, more or fewer fields may be included within the context of the objects 410/420. In various embodiments, these fields are user selectable and may be configured locally or remotely by an operator or user. In various embodiments the number of fields, type of fields, content associated with field and so on may be configured or modified in whole or in part via policy updates provided by the network operator or other network management mechanisms.

Each of the alarm tiles 410 is associated with a corresponding alarm histogram element 420 such that user selection of a particular alarm tile 410 will result in highlighting of the corresponding alarm histogram element. Similarly, user selection of an alarm histogram element will result in highlighting of the corresponding alarm tile 410.

The various objects 410/420 are arranged or sorted in descending order of occurrence; namely, the object for 10/20 associated with the most frequently occurring type of alarm displayed first, while the object 410/420 associated with the least frequently occurring type of alarm is displayed last. Specifically, most frequently occurring type of alarm is that of alarm tile object 410-1, which is displayed at the top of the “top problem alarms” list. Similarly, the corresponding histogram element 420-1 is displayed at the upper left of the histogram as the tallest element in the histogram 420.

The height of an individual histogram element 420 is indicative of the count, occurrence rate and/or impact of a particular alarm represented by that histogram element. It is noted that the various alarm histogram elements are arranged in a three-dimensional histogram wherein a of elements is ordered tallest to shortest from left to right (420-1 through 420-10), a next row forward is ordered tallest to shortest from right to left (420-11 through 420-20), a next row forward is ordered tallest to shortest from left to right (or 20-21 through 420-30), and a front row is ordered tallest to shortest from right to left (420-31 through 420-38). Various and other orderings are also contemplated by the inventors (e.g. arranged front to back, arranged tallest to shortest in the same direction and so on).

For example, referring to FIG. 4, the top problem alarm is represented by alarm tile object 410-1 and comprises “Link Down” alarms generated by 4 network elements which have collectively generated 254 corresponding alarms, which alarms have been repeated 25,400 times. This enormous volume of alarm traffic requires priority handling by the network operator or user so that the alarm causing condition is resolved, the alarms are determined to be unimportant and therefore deleted, or the situation involving alarms is otherwise resolved. Thus, the most frequently occurring alarms within the group of network elements being managed comprise “link down” alarms associated with alarm tile object for ten-1 and histogram element 420-1.

Similarly, the 10^{th} most problematic alarm is represented by alarm tile object 410-10 and comprises “LSP Down” alarms generated by two network elements which have collectively generated 10 corresponding alarms, which alarms have been repeated 10 times. While important, as a matter of efficiency the network operator or user is prompted to address alarms associated with objects 410-1 through 410-9 prior to addressing the alarm associated with object 410-10.

In various embodiments, the objects 410/420 may be color-coded to indicate a level of severity; namely, red color for very frequently generated alarms, yellow color for less frequently generated alarms, green color for those alarms in frequently generated. Thus, in various embodiments, the objects 410/120 may be of differing colors depending upon alarm count, impact and/or other criteria.

In various embodiments, the objects 410/420 may be of differing shapes depending upon health, impact, alarm count or other criteria.

In various embodiments, the objects 410/420 may be of differing sizes ending upon alarm count, impact and/or other criteria.

In various embodiments, the objects 410/420 may be of differing brightness levels ending upon alarm count, impact and/or other criteria.

The user interface display 400 may include display selection “buttons” for determining the type of information/objects displayed within the image region 403, illustratively a “Top Unhealthy NEs” selection button 440, an “Alarm List” selection button 450, a “Top Problems” selection button 460 and an “Inspector” selection button 470. Other selection buttons may also be provided depending upon desired functions. It is noted that the “Top Problem Alarms” selection button 460 is highlighted, indicating that the image region 403 is presently displaying the objects 410/420 associated with the top problem alarms generated by network elements within a group of network elements such as at a network or data center being managed.

The user interface display 400 may include a user identification indicator 480 to identify the particular user or user access level 485, illustratively “admin.”

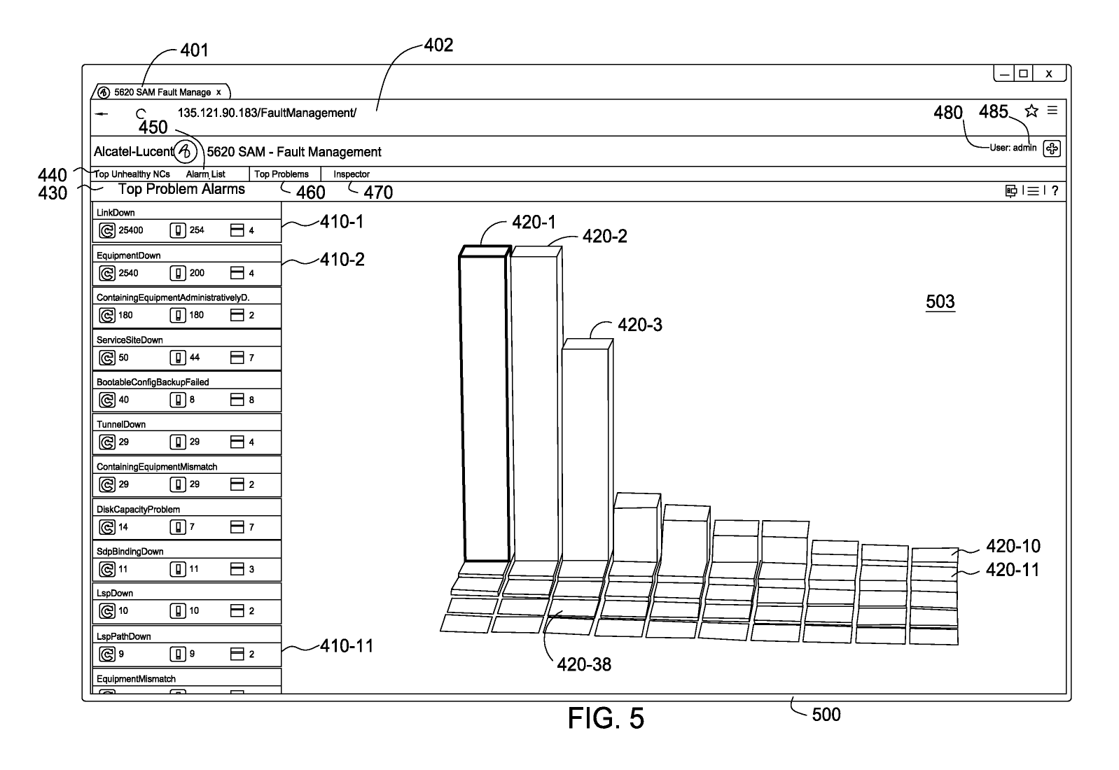

FIG. 5 depicts a user interface screen 500 substantially similar to the user interface screen 400 described above with respect to FIG. 4, except that in FIG. 5 an image region 503 depicts top alarm problem object 410-1 and corresponding histogram element 420-1 being highlighted due to operator or user GUI interaction indicative of a selection of either of top alarm problem object 410-1 or histogram element 420-1.

As noted in field 430, the user interface screen 500 comprises a “Top Problem Alarms” user interface screen.

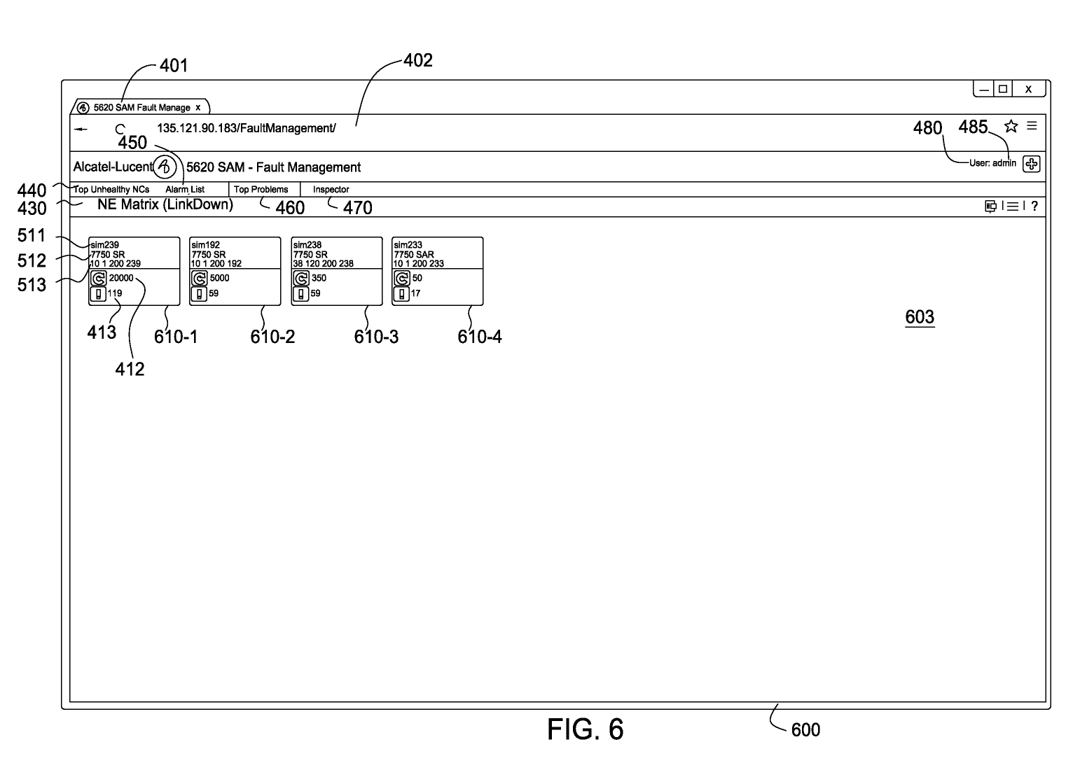

FIG. 6 depicts a user interface screen 600 comprises a top alarm NE interface screen including a plurality of NE representative objects 610; namely NE-representative objects 610-1 through 610-4. Specifically, the objects 610 represent the four network elements associated with the top problem alarm depicted in FIGS. 4-5; namely, 410-1/420-1.

In the depicted embodiment, network element information fields within the network element objects 610 comprise, illustratively, a network or object name field 611, a network element type field 612 and a network element address field 613.

In the depicted embodiment, alarm information fields within the network element objects 610 comprise, illustratively, alarm reoccurrence field 412 and alarm occurrence field 413.

The various fields described herein may comprise default fields, user configurable fields, network provider configurable fields and so on. In addition, more or fewer fields may be included within the context of the network element objects 610. In various embodiments, these fields are user selectable and may be configured locally or remotely by an operator or user. In various embodiments the number of fields, type of fields, content associated with field and so on may be configured or modified in whole or in part via policy updates provided by the network operator or other network management mechanisms.

As noted in field 430, the user interface screen 600 comprises a “NE Matrix (LinkDown)” user interface screen. User interface screen 600 may be generated in response to operator/user selection of network element count field 414 of an object 410/420 as previously discussed. User information screen 600 enables an operator/used to quickly identify which of the underlying network elements associated with the alarm of interest should be investigated first by clearly providing alarm count information and the like.

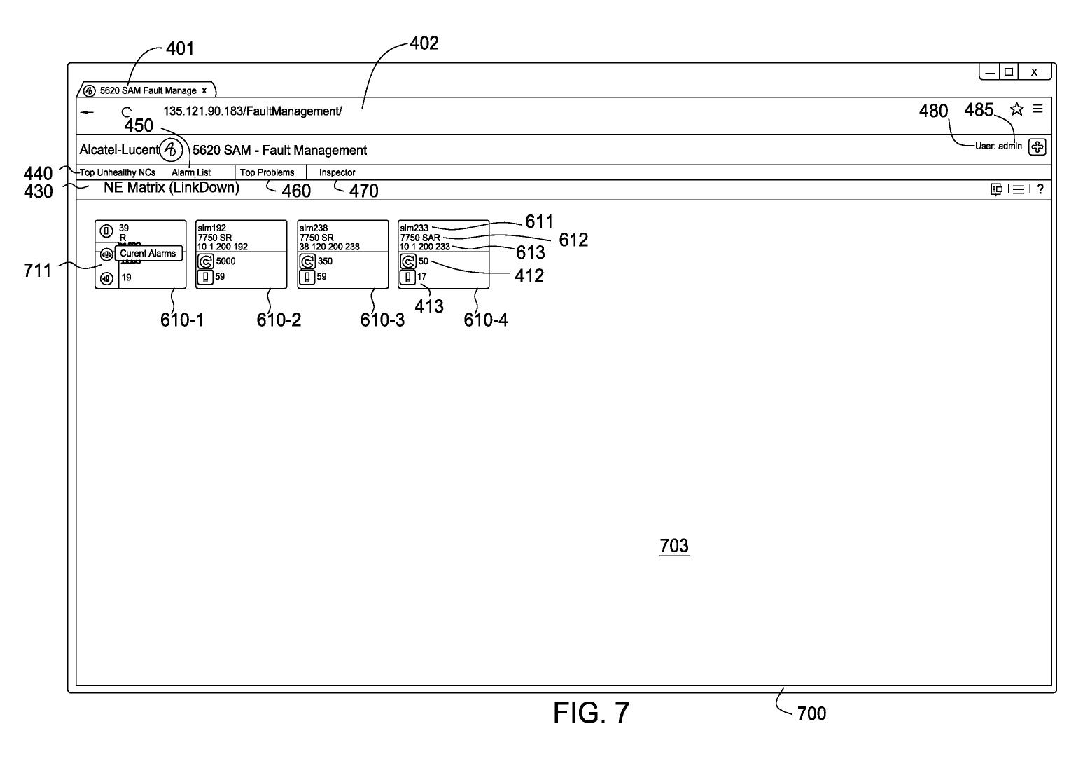

FIG. 7 depicts a user interface screen 700 including a plurality of NE representative objects 610; namely NE-representative objects 610-1 through 610-4 that discussed above with respect to FIG. 6. FIG. 7 depicts an information box 711 indicating “Current Alarms” generated in response to user input such as hovering over the tile 610-1 with a pointing device.

FIG. 8 depicts a high-level block diagram of a computing device, such as a processor in a telecom network element, suitable for use in performing functions described herein such as those associated with the various elements described herein with respect to the figures.

As depicted in FIG. 8, computing device 800 includes a processor element 802 (e.g., a central processing unit (CPU) and/or other suitable processor(s)), a memory 804 (e.g., random access memory (RAM), read only memory (ROM), and the like), a cooperating module/process 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 805 can be loaded into memory 804 and executed by processor 802 to implement the functions as discussed herein. Thus, cooperating process 805 (including associated data structures) can be stored on a computer readable storage medium, e.g., RAM memory, magnetic or optical drive or diskette, and the like.

It will be appreciated that computing device 800 depicted in FIG. 8 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

The various embodiments contemplate an apparatus configured to provide ranking and visualization functions in accordance with the various embodiments, the apparatus comprising a processor and a memory communicatively connected to the processor, the processor configured to perform various ranking and visualization functions as described above with respect to the figures.

The various embodiments allow NEs to be identified and prioritized in the network based on which ones contain the most re-occurring alarms. In this manner, an operator or user is provided with a human understandable way to tackle the problem of which NEs should be investigated first to eliminate storms of alarms. It allows the user to understand where to direct their efforts to get the biggest result for the least amount of effort. Also, the feature will offer quick second steps to start a troubleshooting investigation and to verify exactly what the problem is. Potentially, the alarm causing the problem could be eliminated right in the feature.

In one embodiment, the operator or user is presented with a histogram comprising N (e.g., 50) individual histogram elements or bars, each representing an alarm type. By default the bars in the histogram may be ordered (prioritized) based on the re-occurrence numbers of the alarms that they represent. Optionally, the bars may be ordered by the total number of alarms that exist of the type represented by the bar. The operator or user may select (via the GUI) one of the bars (histogram elements) to invoke thereby a new GUI image in which a matrix of the top N (e.g., 50) NEs that contain the alarm type represented by the selected bar. The matrix may be prioritized (ordered) to indicate the worst offending NE (e.g., per most alarms or other criteria) at the top left and the least offending NE at the bottom right. Other positions and arrangements are also contemplated by the inventors. The operator or user may optionally hide an offending NE's alarm within the visualization. Once the worst NE is eliminated from the matrix, then the N+1 (e.g., 51^{st}) worst offending NE may be added.

Advantageously, the various embodiments help an operator or user identify and prioritize the NEs in their networks that need to be investigated for causing large numbers of alarms. Further, by providing for self-identifying NEs (i.e., those with alarm generation or related problems), the various embodiments remove operator or user judgment as to where to begin troubleshooting, and where to continue troubleshooting. Further, the various embodiments eliminate the need for time consuming and error prone methods of filtering and sorting an alarm list that could contain 500,000+ individual alarms for a network. Thus, the network management functions are improved and network alarm congestion is reduced by quickly and efficiently removing meaningless alarms generated from the worst offending NEs.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. An apparatus for managing a plurality of network elements within a network, the apparatus comprising:
a processor and a memory communicatively connected to the processor, the processor configured for:
retrieving, for at least a portion of the network elements to be managed, respective alarm information;
performing a ranking function configured to rank alarm types according to at least one of a group consisting of alarm occurrence information and alarm impact information; and
performing an alarm visualization function configured to provide image representative data including a group of objects, each object being indicative of alarm occurrence information associated with a respective alarm type, said group of objects being arranged within an image region in accordance with said ranking.

2. The apparatus of claim 1, wherein said alarm occurrence information associated with an alarm type comprises an alarm count.

3. The apparatus of claim 2, wherein said alarm count comprises a count of at least one of a group consisting of: critical alarm count, major alarm count, minor alarm count and warning count.

4. The apparatus of claim 2, wherein said alarm count comprises a weighted alarm count.

5. The apparatus of claim 1, wherein said alarm occurrence information comprises an alarm occurrence rate.

6. The apparatus of claim 5, wherein said alarm occurrence rate comprises an occurrence rate of at least one of a group consisting of: critical alarm occurrence rate, major alarm occurrence rate, minor alarm occurrence rate and warning occurrence rate.

7. The apparatus of claim 6, wherein said alarm occurrence rate comprises a weighted alarm occurrence rate.

8. The apparatus of claim 1, wherein said impact information comprises a number of downstream network elements impacted by alarms of said alarm type.

9. The apparatus of claim 1, wherein said impact information comprises a number of network elements generating alarms of said alarm type.

10. The apparatus of claim 1, wherein said processor is further configured for:
performing a network element visualization function in response to data indicative of a selection of an object associated with an alarm type, said network element visualization function configured to provide image representative data including a group of objects, each object providing identification information and at least a portion of alarm related information associated with a respective one of network elements associated with said selected object alarm type, said group of objects being arranged within an image region.

11. The apparatus of claim 10, wherein said processor is further configured for:
performing a ranking function configured to rank said network elements associated with said selected object alarm type according to respective alarm occurrence information;
said group of objects being arranged within said image region in accordance with said network element ranking.

12. The apparatus of claim 11, wherein said network element alarm information used to determine said network element ranking comprises at least one of an alarm count and a weighted alarm count.

13. The apparatus of claim 1, wherein said group of objects comprises a selectable number of objects, said processor being further configured for including within said group of objects a number of objects defined by received object display criteria.

14. The apparatus of claim 1, wherein each of said objects is associated with a color parameter selected in accordance with a ranking of alarm level.

15. The apparatus of claim 1, wherein said group of objects are arranged as a plurality of histogram elements, wherein relative histogram element size is determined by corresponding alarm count information.

16. The apparatus of claim 15, wherein:
said group of objects comprises a first group of objects;
said alarm visualization function is further configured to provide image representative data including a second group of objects, each object within said second group of objects being indicative of alarm information of a respective object from said first group of objects;
said second group of objects being arranged within a second image region in accordance with said ranking.

17. The apparatus of claim 16, wherein said second group of objects arranged as a plurality of tile elements.

18. A tangible and non-transient computer readable storage medium storing instructions which, when executed by a computer, adapt the operation of the computer to perform a method for managing a plurality of network elements within a network, the method comprising:
retrieving, for at least a portion of the network elements to be managed, respective alarm information;
performing a ranking function configured to rank alarm types according to at least one of a group consisting of alarm occurrence information and alarm impact information; and
performing an alarm visualization function configured to provide image representative data including a group of objects, each object being indicative of alarm occurrence information associated with a respective alarm type, said group of objects being arranged within an image region in accordance with said ranking.

19. A computer program product wherein computer instructions, when executed by a processor in a network element, adapt the operation of the network element to provide a method for managing a plurality of network elements within a network, the method comprising:
retrieving, for at least a portion of the network elements to be managed, respective alarm information;
performing a ranking function configured to rank alarm types according to at least one of a group consisting of alarm occurrence information and alarm impact information; and
performing an alarm visualization function configured to provide image representative data including a group of objects, each object being indicative of alarm occurrence information associated with a respective alarm type, said group of objects being arranged within an image region in accordance with said ranking.
